(19) United States
(12) Patent Application Publication
(10) Pub. No.: US 2026/0220367 A1
(43) Pub. Date: Jul. 30, 2026

(54) SYSTEM AND METHOD FOR ESTIMATING AN OPTIMAL SIZE OF A CONTEXT WINDOW FOR LLMs

(71) Applicant: Honeywell International Inc., Charlotte, NC (US)

(72) Inventors: Waad Subber, Schenectady, NY (US); Ankit Singh, Apex, NC (US); Eric Hartye, Oak Ridge, TN (US); Jason Halpern, Elkins Park, PA (US)

(21) Appl. No.: 19/036,198

(22) Filed: Jan. 24, 2025

(51) Int. Cl. G06F 40/284; G06F 40/30

(52) U.S. Cl. CPC G06F 40/284; G06F 40/30

(57) ABSTRACT

The present disclosure discloses a system that iteratively computes the optimal size for the context window such that the optimal size of the input data fits within the threshold size of the context window. In an embodiment, the system invokes the LLM to perform a specific task using output that is generated after the iterative computation as a dataset and the optimal size for the context window. The disclosed methodology addresses the issue of limited window size in LLMs by reducing the redundancies in the input data by iterative computation. Further, the disclosed methodology eliminates the need to call the LLM often to generate a response or prediction.

### FIELD OF INVENTION

The present disclosure generally relates to Large Language Models (LLMs). More specifically, the present disclosure provides a system and a method for estimating an optimal size of a context window for LLMs.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Large Language Models (LLMs) are powerful computational models designed to understand, process, and generate text based on extensive training data. The LLMs play an essential role in generating responses and predicting the content from various inputs like documents, texts, images, videos, web pages, queries, and the like. The LLMs can comprehend and analyze large volumes of textual data by utilizing deep learning techniques. Further, the LLMs are capable of producing contextually appropriate responses, effectively based on the input prompts or context. Additionally, the LLMs are useful in performing specific tasks such as document summarization, where the LLMs process complex documents into concise and meaningful summaries based on the ability to capture long-range dependencies in text.

In general, the LLMs utilize a context window defined with a specific token limit to process input data and generate responses. The context window in the LLMs refers to the amount of text or tokens that the LLMs can consider when generating the responses or making predictions. The context window is essentially a range or a window of tokens that the LLMs considers when processing the input data and producing an output. For example, Generative Pre-Trained Transformers (GPT) may be defined to allow 4096 token limit within a single context window. If the input data exceeds the defined token limit, then system can encounter an error depicting the inability to handle such an extensive request.

Accordingly, the size of the context window significantly influences the LLMs capability to capture long-range dependencies in the input data. Furthermore, the context window competes for space with the LLMs response. A lengthier context leaves less room for the response, introducing potential challenges if the response is also extensive.

According to a state-of-the-art solution, a map-reduce approach is utilized in order to overcome the issues of the limited size of the context window in LLMs. The map-reduce approach typically includes two steps, i.e., the map step and the reduce step. In the map step, a summarization is performed for chunks of large input data to produce a set of summaries, and then the reduced step is applied to produce a consolidated summary of the set of summaries. While the map-reduce approach can be parallelized, allowing it to scale for large input data, however, this leads to an increase in costs. As the number of chunks of input data increases, the corresponding calls to the LLMs also increase simultaneously thereby making such an approach ineffective.

According to another state-of-art solution, a refine method is utilized for summarizing the large input data. The refine method typically includes iteratively updating the responses by processing new chunks of the input data in each iteration. In this approach, the context window for each iteration encompasses the latest summary obtained from the previous iteration along with a new chunk of the input data to refine the new summary. According to this approach, calls to the LLMs are performed sequentially in the refine method. As the call to the LLMs is sequentially performed, utilizing such an approach is also ineffective.

Accordingly, the state-of-the-art approaches involve increased processing overhead due to iterative processing, increased resource consumption from sequential processing, and repeated calls to LLMs which leads to an increase in cost.

Thus, there is a need to provide a technique to mitigate the above-mentioned issues related to the size of the context window in the LLMs.

Through applied effort, ingenuity, and innovation, the inventors have solved and proposed the above problem(s) by developing the solutions embodied in the present disclosure, the details of which are described further herein.

### SUMMARY OF THE INVENTION

In general, embodiments of the present disclosure herein provide a solution for estimating an optimal size for a context window of a large language model (LLM). Other implementations will be or will become, apparent to one with skill in the art upon examination of the following figures and detailed description. It is intended that all such additional implementations be included within this description within the scope of the disclosure.

In one embodiment, the present disclosure discloses a method for estimating an optimal size for a context window of a large language model (LLM). The method includes receiving input data for performing a specific task. The input data has a size more than a threshold size of the context window. The method further includes iteratively computing the optimal size, for the context window, such that the optimal size fits within the threshold size of the context window. The iterative computation of the optimal size includes splitting the input data into a plurality of segments, where each of the plurality of segments is split into a first size that is less than the threshold size of the context window. In an embodiment, the iterative computation further includes determining an optimal number of one or more groups of segments, among the plurality of segments, where each of the one or more groups of segments is semantically close to each other. The iterative computation further includes obtaining, based on clustering of the one or more groups of segments, one or more clusters of segments having a vector similarity within each of the one or more clusters of segments. The iterative computation further includes selecting, from each of the one or more clusters of segments, a representative segment that is closest to a center of each of the one or more clusters of segments to obtain a set of representative segments. Further, the iterative computation includes performing the specific task by passing each representative segment, of the set of representative segments, through the LLM to obtain a first output corresponding to each of the representative segment and obtaining, based on combining the first output, a second output of a specific size. In an embodiment, based on a result of the iterative computation where the specific size of the second output fits within the threshold size of the context window of the LLM after an iteration, the method further includes estimating that the specific size is the optimal size for the context window for performing the specific task using the LLM.

According to some embodiment, the present disclosure discloses a system for estimating an optimal size for a context window of a large language model (LLM). The system includes one or more processors, the memory, and one or more programs stored in the memory. In an embodiment, the one or more programs when executed by the one or more processors, cause the one or more processors to receive input data for performing a specific task, where the input data has a size more than a threshold size of the context window. In an embodiment, the one or more processors are configured to iteratively compute the optimal size, for the context window, such that the optimal size fits within the threshold size of the context window. According to an embodiment, for the iterative computation of the optimal size, the one or more processors are configured to split the input data into a plurality of segments, where each of the plurality of segments is split into a first size that is less than the threshold size of the context window. Further, the one or more processors are configured to determine an optimal number of one or more groups of segments, among the plurality of segments, where each of the one or more groups of segments is semantically close to each other. The one or more processors are further configured to obtain, based on clustering of the one or more groups of segments, one or more clusters of segments having a vector similarity within each of the one or more clusters of segments. Further, the one or more processors are further configured to select, from each of the one or more clusters of segments, a representative segment that is closest to a center of each of the one or more clusters of segments to obtain a set of representative segments. Further, the one or more processors are configured to perform the specific task by passing each representative segment, of the set of representative segments, through the LLM to obtain a first output corresponding to each of the representative segment and obtain, based on combining the first output, a second output of a specific size. In an embodiment, based on a result of the iterative computation where the specific size of the second output fits within the threshold size of the context window of the LLM after an iteration, the one or more processors are further configured to estimate that the specific size is the optimal size for the context window for performing the specific task using the LLM.

According to some embodiment, the present disclosure discloses a non-transitory computer-readable storage medium storing program instructions for estimating an optimal size for a context window of a large language model (LLM). According to an embodiment, the instructions when executed, perform the steps of receiving input data for performing a specific task. The input data has a size more than a threshold size of the context window. The step further includes iteratively computing the optimal size, for the context window, such that the optimal size fits within the threshold size of the context window. The iterative computation of the optimal size includes splitting the input data into a plurality of segments, where each of the plurality of segments is split into a first size that is less than the threshold size of the context window. In an embodiment, the iterative computation further includes determining an optimal number of one or more groups of segments, among the plurality of segments, where each of the one or more groups of segments is semantically close to each other. The iterative computation further includes obtaining, based on clustering of the one or more groups of segments, one or more clusters of segments having a vector similarity within each of the one or more clusters of segments. The iterative computation further includes selecting, from each of the one or more clusters of segments, a representative segment that is closest to a center of each of the one or more clusters of segments to obtain a set of representative segments. Further, the iterative computation includes performing the specific task by passing each representative segment, of the set of representative segments, through the LLM to obtain a first output corresponding to each of the representative segment and obtaining, based on combining the first output, a second output of a specific size. In an embodiment, based on a result of the iterative computation where the specific size of the second output fits within the threshold size of the context window of the LLM after an iteration, the step further includes estimating that the specific size is the optimal size for the context window for performing the specific task using the LLM.

The above summary is provided merely for the purpose of summarizing some exemplary embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject will become apparent from the description, the drawings, and the claims.

### DESCRIPTION OF THE DRAWINGS

Having thus described the embodiments of the disclosure in general terms, reference now will be made to the accompanying drawings, which are not necessarily drawn to scale, and wherein:

FIG. 1A illustrates a general architecture of LLM, according to an embodiment of the present disclosure;

FIG. 1B illustrates an example of a context window, according to an embodiment of the present disclosure;

FIG. 2 illustrates a detailed block diagram for estimating an optimal size for a context window of a large language model (LLM), according to an embodiment of the present disclosure;

FIG. 3 illustrates a method flow for iterative computation, according to an embodiment of the present disclosure;

FIG. 4 illustrates an example for estimating the optimal size of the context window of the LLM, in case a large document is input data, according to an embodiment of the present disclosure;

FIG. 5 illustrates an overall method flow of the system 200, according to an embodiment of the present disclosure; and

FIG. 6 illustrates a general block diagram of the system, according to an embodiment of the present disclosure.

### DESCRIPTION OF THE INVENTION

The detailed description set forth below in connection with the appended drawings is intended as a description of various embodiments of the present invention and is not intended to represent the only embodiments in which the present invention may be practiced. Each embodiment described in this invention is provided merely as an example or illustration of the present invention, and should not necessarily be construed as preferred or advantageous over other embodiments. The detailed description includes specific details for the purpose of providing a thorough understanding of the present invention. However, it will be apparent to those skilled in the art that the present invention may be practiced without these specific details.

Some embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

In one embodiment, the present disclosure discloses a methodology for LLMs for estimating an optimal size for a context window of a large language models (LLMs). More particularly, the disclosed methodology provides an automated approach to estimate the optimal size of the context window thereby invoking the LLM optimally. According to an embodiment, the system framework is based on clustering and dimensionality reduction techniques for chunks of input data that have a size more than a threshold size of a context window of the LLMs.

In an embodiment, the system iteratively computes the optimal size for the context window such that the optimal size of the input data fits within the threshold size of the context window. In an embodiment, the system invokes the LLM to perform a specific task using output that is generated after the iterative computation as a dataset and the optimal size of the context window. The disclosed methodology addresses the issue of limited window size in LLMs by reducing the redundancies in the input data by iterative computation. Thus, the disclosed methodology eliminates the need to call the LLM often to generate a response or prediction. The forthcoming paragraphs describe a detailed implementation of estimating the optimal size for the context window. The technical effect will be evident through the description provided in the forthcoming paragraphs.

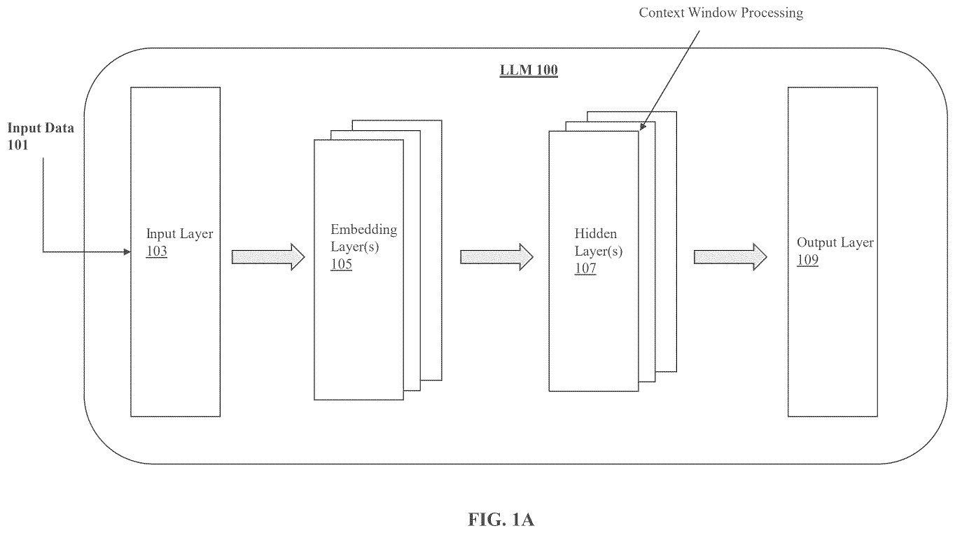

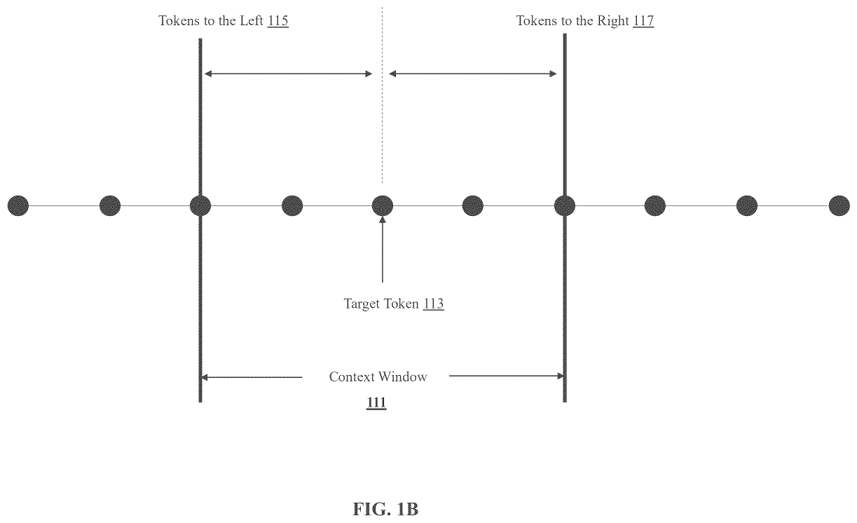

FIG. 1A illustrates a general architecture of LLM, according to an embodiment of the present disclosure. According to an embodiment, the LLM 100 operates on the principles of deep learning techniques leveraging neural network (NN) architectures to process and understand the input data 101. The LLM 100 architecture is determined by a number of factors, like the objective of the specific model design, the available computational resources, and the kind of tasks that are to be carried out by the LLM.

According to an embodiment, the LLM 100 includes a plurality of layers comprising an input layer 103, an embedding layer(s) 105, a hidden layer(s) 107, and an output layer 109 that processes the input data 101 of various modalities. In a non-limiting example, the input data 101 may be extensive documents, audio files, video files, queries, texts, and the like. According to an example embodiment, the LLM 100 is capable of performing specific tasks, for example, summarizing the documents, the audio files, the video files, the texts, and the like. According to another example embodiment, the LLM 100 is capable of performing specific tasks, for example, comparing the documents, the audio files, the video files, the texts, and the like. According to yet another example embodiment, the LLM 100 is capable of performing specific tasks, for example, extracting specific content from the documents, or answering in response to the queries related to the documents, the audio files, the video files, and the texts.

In an embodiment, based on the specific task that is to be performed by the LLM 100, the input layer 103 receives the input data 101 of various modalities and processes it. Thus, each type of the input data 101 (i.e. the document, the video files, the audio files, the queries) is inputted to the LLM 100 through its corresponding input layer. The input layer 103 processes the input data 101. For example, the input data 101 corresponds to the document or the queries, and the input layer 103 performs operations such as text pre-processing and tokenization. The output obtained from the aforesaid step is then passed on to the subsequent layers. In another example, for the video file or the audio file as the input data 101, the input layer 103 performs operations such as frame pre-processing, and feature extraction. The output obtained from the aforesaid step is then passed on to the subsequent layers.

In an embodiment, the output from the input layer 103 is passed to the embedding layer(s) 105 that converts the pre-processed input data into dense, lower-dimensional representations capturing important features, context, and semantic meaning in the input data 101. The output of the embedding layers(s) 105 is further passed on to the hidden layer(s) 107 for further processing.

In an embodiment, the hidden layer(s) 107 applies context window processing within the hidden layer(s) 109. The context window processing 109 allows the LLM 100 to consider the processing of each input token of the input data within the context window.

FIG. 1B illustrates an example of a context window, according to an embodiment of the present disclosure. As explained in the above paragraphs, the context window 111 is defined with the specific token limit having a threshold size. In particular, the threshold size of the context window 111 is the number of tokens both preceding and following a specific word or character i.e. a target token 113. Thus, the size of the context window limits the number of tokens considered within the context window 111.

In an embodiment, the hidden layer(s) 107 is further implemented with various AI/ML mechanisms to perform various operations to, capture dependencies and contextual relationships within the input data. As an example, the AI/ML mechanism may include recurrent operations, convolutional operations, self-attention mechanisms, or other suitable architectures. In an embodiment, after undergoing processing within the hidden layer(s) 107, the output layer 109 generates outputs or performs various language-related tasks based on the contextual understanding gained from the input modalities.

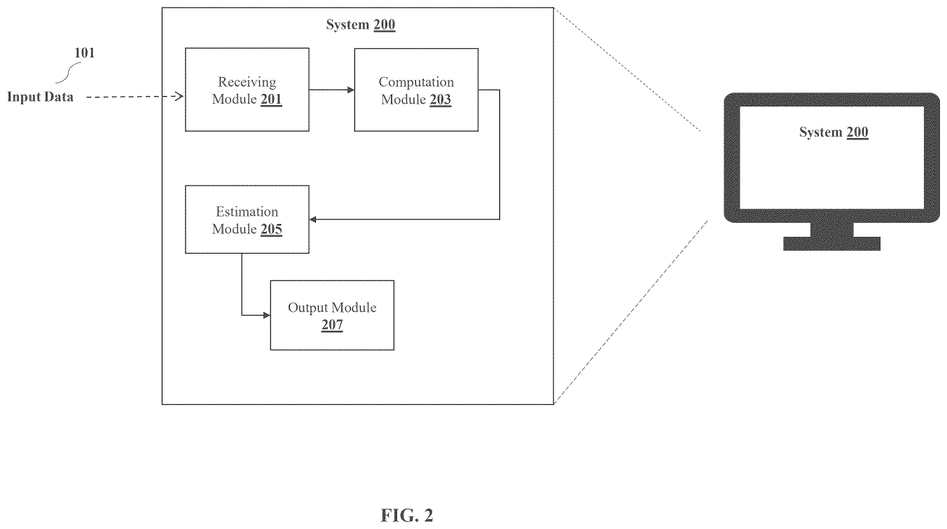

FIG. 2 illustrates a detailed block diagram for estimating an optimal size for a context window of a large language model (LLM), according to an embodiment of the present disclosure. According to an embodiment, FIG. 2 depicts a system 200 comprising one or more modules for estimating the optimal size for the context window of the LLMs. In a non-limiting example, the system 200 may be a computer, a laptop, a physical server, a virtual server, a cloud-based server, or any electronic machine. According to an embodiment, the system 200 may be implemented with an application providing AI-powered solutions for specific task using the LLMs 100. According to an embodiment, the system 101 includes a receiving module 201, a computation module 203, an estimation module 205, and an output module 207 coupled with each other. According to an embodiment, the receiving module 201, the computation module 203, the estimation module 205, and the output module 207 are uniquely designed hardware modules or software modules.

According to some embodiments, functions of the receiving module 201, the computation module 203, the estimation module 205, and the output module 207 can be performed by the processor(s). According to some embodiment, the receiving module 201, the computation module 203, the estimation module 205, and the output module 207 can be a part of an AI framework of the application to develop the AI-powered solutions for the specific tasks. Further, an explanation will be made by referring to modules depicted in FIG. 2. Furthermore, the labels depicted in the representative drawings are kept the same for similar components throughout the disclosure for ease of understanding. A detailed explanation of each module will be explained in the forthcoming paragraphs.

According to an embodiment, the receiving module 201 receives the input data 101 for performing the specific task. In a non-limiting example, the specific task can be the summarization of the input data 101, the comparison between input data 101, extracting specific content from the input data 101, and answering in response to the queries related to the input data 101. In an embodiment, the input data 101 has a size more than a threshold size of the context window of the LLM 100. The threshold size of the context window 111 is the size that the LLM 100 is capable of successfully processing the input data 101.

According to an embodiment, the computation module 203 receives the input data 101 and computes the optimal size for the context window 111 such that a specific size of the input data is the optimal size for the context window for performing the specific task using the LLM so that the specific size of the input data 101 fits within the threshold size of the context window 111. According to an embodiment, the LLM 100 as depicted in FIG. 1A is deployed within the computation module 203. According to some embodiment, the LLM 100 can be deployed in the virtual server, the cloud-based server, or the application providing AI-powered solutions for the specific task. According to an embodiment, the computation module 203 iteratively computes the optimal size for the context window 111, such that the specific size of the input data 101 is the optimal size for the context window for performing the specific task using the LLM 100 so that the specific size of the input data 101 fits within the threshold size of the context window 111. According to an embodiment, the computation module 203 performs a series of operations based on clustering and dimensionality reduction techniques on the input data 101 to obtain an output of a specific size.

In an embodiment, the estimation module 205 estimates whether the specific size of the output is the optimal size for the context window 111 such that the output, obtained after the iterative computation, can fit within the threshold size of the context window 111. For doing so, the estimation module 205 compares the specific size of the output with the threshold size of the context window 111. Further, the estimation module 205 determines whether the specific size of the output fits within the threshold size of the context window based on a result of the comparison. If the estimation module 205 determines that the specific size of the output is the optimal size that fits within the threshold size of the context window 111, then the estimation module 205 passes the specific size and the output to the output module 207 for further processing.

On the other hand, if the estimation module 205 determines that the specific

size of the output does not fit within the threshold size of the context window 111, then the result of the determination is passed on to the computation module 203 for repeating the iterative computation for obtaining the specific size that fits within the threshold size of the context window. In such a case, the output from a previous iteration is considered as the input data for a next iteration. The output thus obtained after each iteration includes non-redundant input data due to iteratively performing the series of operations on the input data obtained from the previous iteration.

In an embodiment, the output module 207 invokes the LLM 100 to finally perform the specific task with the output, obtained after the completion of the iterative computation, as a dataset to the LLM 100 and considering the optimal size of the context window 111 estimated by the estimation module 205. The disclosed methodology addresses the issue of limited window size in LLMs by reducing the redundancies in the input data by iterative computing and further eliminates the need to call the LLM often to generate a response or prediction. The working of each module as depicted in FIG. 2 will be explained in detail in the forthcoming paragraphs through the drawings FIG. 1A to 6.

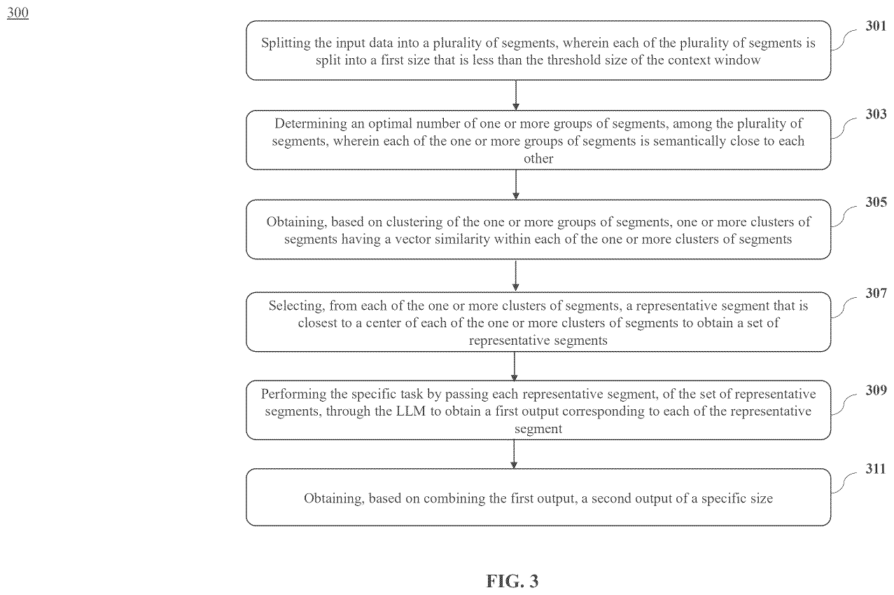

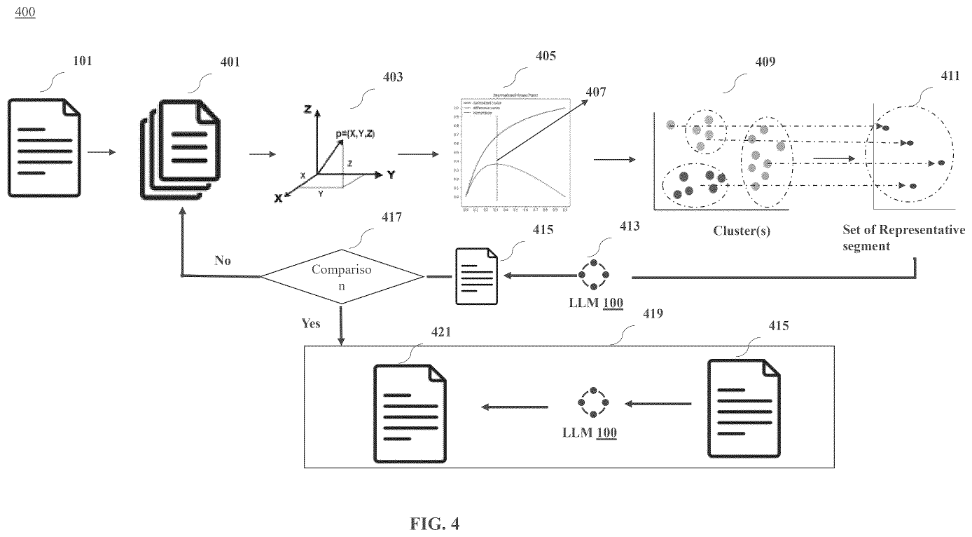

FIG. 3 illustrates a method flow for iterative computation, according to an embodiment of the present disclosure. According to an embodiment, the iterative computation 300 is implemented in the computation module 203. According to an embodiment, as the input data 101 is received by the computation module 203, the computation module 203, at step 301, splits the input data 101 into a plurality of segments. According to an embodiment, the computation module 203 splits the large input data 101 like large documents, the audio files, or the video files video to obtain meaningful segments. In an embodiment, each of the plurality of segments is split into a size such that the size of each segment is less than the threshold size of the context window 111. The ‘segments’ can be alternatively referred to as ‘chunks’ throughout the disclosure.

As an example, the documents can be split into a number of tokens, words, and paragraphs using NLP techniques. Further, the audio input and the video input can be split into a plurality of frames and subframes using state-of-the-art techniques of audio and video processing techniques. Explanation will be made by considering, the large document as the input data 101 as an example, hence shall not be construed as limiting.

FIG. 4 illustrates an example for estimating the optimal size of the context window of the LLM, in case a large document is input data, according to an embodiment of the present disclosure. Method 400 depicts an example for estimating the optimal size of the context window 111 of the LLM 100, in case a large document 101 is the input data. As can be seen, at block 401, the document 101 is split into n number of chunks with a size less than the threshold size of the context window limit.

Referring back to FIG. 3, after splitting the input data, the computation module 203 extracts a plurality of features from each segment. Further, each segment is embedded in a vector space to represent each segment as a vector. In particular, each segment is converted into numerical vectors that capture the semantic meanings and relationships between each content within the segment.

Accordingly, the computation module 203 represents the plurality of features in each segment as a plurality of data points in a vector using vector embedding techniques. Further, the computation module 203 obtains a plurality of vectors representing the plurality of features in the plurality of segments in a vector space. As an example, techniques like dimensionality reduction, normalization, and aggregation can be applied to the extracted features. Block 403 of FIG. 4 depicts an example of representing n number of document chunks in the vector space of fixed dimension. By creating the vector representation of the input data, it becomes possible to apply ML models and algorithms to analyze, classify, and understand the content of the input data.

In an embodiment, at step 303, the computation module 203 determines an optimal number of groups of segments among the plurality of segments. In an embodiment, the groups of segments are determined such that each of the groups of segments is semantically close to each other. In an embodiment, an optimal clusters determination technique like the Elbow method is used to obtain the optimal number of groups of segments. The optimal number of groups of segments identifies an ideal number of clusters that best represent the structure of the input data.

According to an embodiment, for applying the optimal clusters determination technique, the computation module 203 applies clustering techniques on the plurality of vectors and obtains clusters of data points having semantically close data points. For example, clustering technique, such as K-means, can be applied to the vector representations to group the data points into clusters based on their similarities in the high-dimensional space. Thus, each cluster is a cluster of data points.

Further, the computation module 203 for each cluster configuration calculates a sum of a squared error factor. This involves computing the squared distances between the vectors of the data points and the centroids of their respective clusters. Accordingly, the computation module 203 calculates the sum of the squared error factor for each of the clusters of data points. In an embodiment, the sum of the squared error factor values corresponding to different numbers of clusters are plotted to determine the optimal number of groups of segments from the clusters of data points. In an embodiment, the optimal number of groups has an optimal compactness of the data points within each of the one or more clusters of data points.

In an embodiment, the computational module 203 determines the optimal number of groups of segments based on the point on the plot where the sum of the squared error factor starts to slow down significantly. As shown in block 405, a plotting of the sum of the squared error factor values corresponding to different numbers of clusters is depicted. As can be seen, point 407 on the plot is the point where the sum of the squared error factor starts to slow down significantly. Thus, the optimal number of groups of segments provides the most appropriate number of clusters for a given dataset based on the analysis of the vector representations and their clustering characteristics.

In an embodiment, after determining the optimal number of groups of

segments, the computational module 203, at step 305, applies clustering techniques to cluster the groups of segments as obtained in step 303. Based on the clustering of the groups of segments, the computational module 203 obtains one or more clusters of segments having a vector similarity within each of the one or more clusters of segments.

In particular, for performing step 305, the computational module 203 determines the vector similarity between the groups of segments using clustering techniques like k-means algorithm. For example, the computational module 203 computes the vector similarity between these segments utilizing a similarity metric like cosine similarity. This quantifies the similarity between the vector representations of different segments in the group. Further, the computational module 203 clusters the groups of segments using clustering techniques and obtains one or more clusters of segments having the vector similarity within each of the one or more clusters of segments. Thus, the cluster of segments is a group of segments that exhibit high vector similarity and are semantically close to each other. Bock 409 of FIG. 4 depicts the one or more clusters of segments having a vector similarity within each other.

According to an embodiment, at step 307, the computation module 203 selects one representative segment from each of the one or more clusters of segments that are closest to a center of each of the one or more clusters of segments to obtain a set of representative segments. As can be seen in block 411 of FIG. 4, a set of representative segments is obtained by selecting a representative segment from each cluster shown in block 409.

According to an embodiment, at step 309, the computation module 203 performs the specific task by passing the set of representative segments, through the LLM 100 as shown in block 413 of FIG. 4. In an embodiment, each of the representative segments is passed to the LLM for performing the specific task. For example, if the LLM 100 is to be used for generating a summary, then the LLM 100 performs a summarization of each representative segment in parallel as the representative segments are independent of each other. Accordingly, the computation module 203 obtains an output corresponding to each of the representative segments. The output hence obtained may be referred to as an intermediate output where the specific task is performed for each representative segment.

In an embodiment, the computation module 203 combines all the intermediate output to form one large chunk of output. Accordingly, at step 311, the computation module 203 obtains a combined output 415 of a specific size. The combined output 415 is shown in FIG. 4. According to an embodiment, the combined output 415 includes segments with non-redundant input data. As input data 101 undergoes a series of operations from steps 301 to 309, the dimensionality and redundancy of the input data 101 are reduced. Each step of 301 to 309 aids in removing the redundancy in the input data 101.

According to an embodiment, after performing the series of operations for a first iteration as explained in method 300, the estimation module 205 estimates whether the specific size of the combined output 415 is the optimal size for the context window 111 such that the LLM 100 can successfully perform the specific task. For doing so, the estimation module 205, compares the specific size of the combined output 415 with the threshold size of the context window 111. An example of comparison is shown in block 417 of FIG. 4. If the estimation module 205 determines that the specific size of the combined output 415 fits within the threshold size of the context window 111 based on a result of the comparison, then the estimation module 205 estimates the specific size of the combined output 415 as the optimal size for the context window 111. Accordingly, the estimation module 205, sends the combined output 415 along with the specific size to the output module 207.

In an embodiment, the output module 207 invokes the LLM 100 for performing the specific task by considering the combined output 415 as a dataset for the LLM 100. For the example depicted in FIG. 4, the output module 207 performs the process at block 419, as can be seen, the LLM 100 receives the combined output 415 as the dataset and generates a final summary 421 of the document 101.

Further, in case the estimation module 205 determines that the specific size of the combined output 415 does not fit within the threshold size of the context window 111 based on a result of the comparison, then the estimation module 205 repeats steps 301 through 311 to perform the next iteration. Accordingly, the combined output 415 of the first iteration becomes an input to the next iteration. Thus, in the next iteration, the computation module 203 uses the combined output 415 as input data for performing the splitting operation and so on. In an embodiment, the iterative computation 300 is performed till the specific size of the combined output becomes an optimal size so as to fit within the threshold size of the context window 111. Thus, the disclosed methodology addresses the issue of limited window size in LLMs by reducing the redundancies in the input data by iterative computation. Thus, the disclosed methodology eliminates the need to call the LLM often to generate a response or prediction.

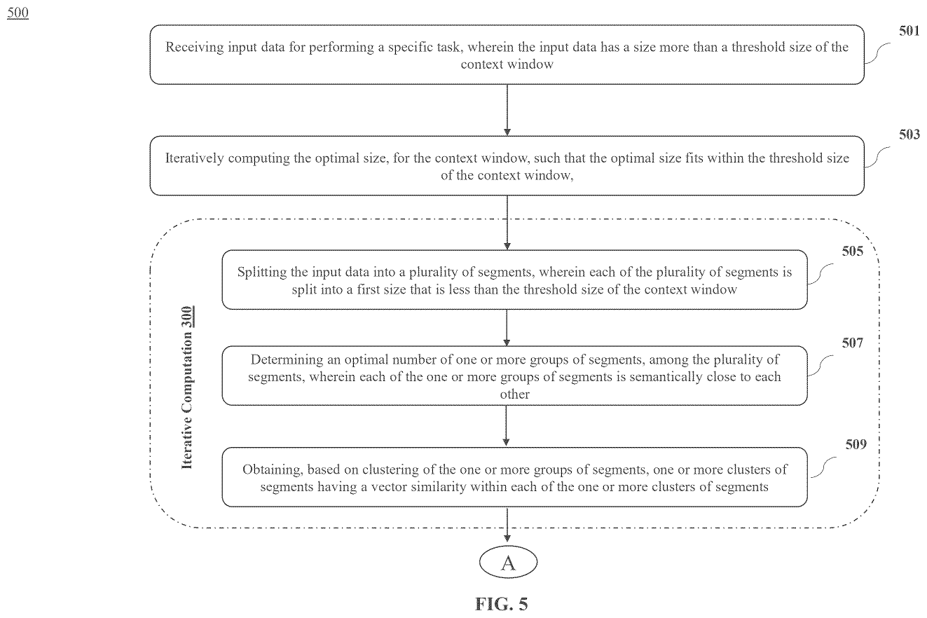

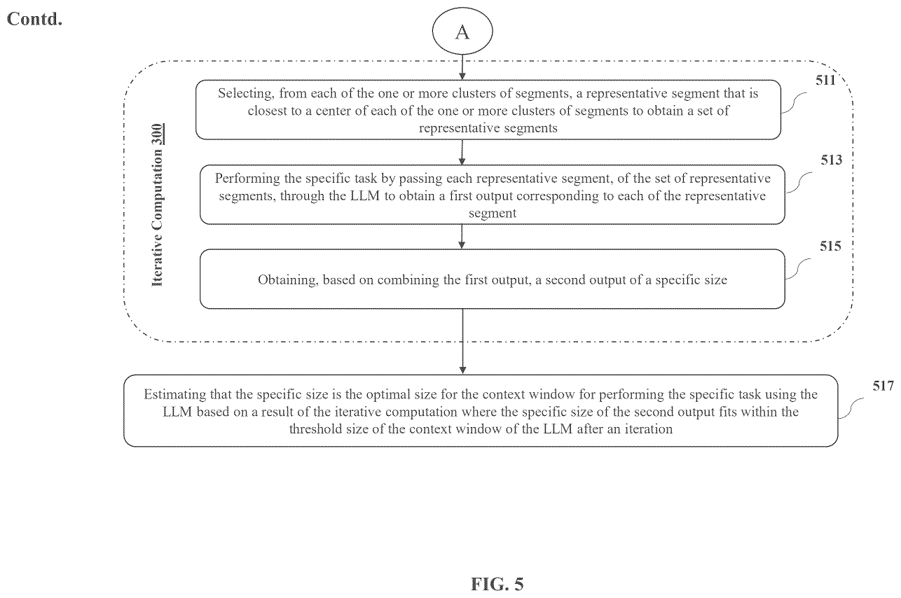

FIG. 5 illustrates an overall method flow of the system 200, according to an embodiment of the present disclosure. According to an embodiment, the method 500 is implemented in the system 200. A detailed explanation of the steps is explained through FIGS. 1A-4, therefore the same is omitted here for the sake of brevity.

According to an embodiment, the method 500, at step 501 includes receiving input data 101 for performing a specific task. In an embodiment, the input data 101 has the size more than the threshold size of the context window 111. According to an embodiment, the receiving module 201 receives the input data 101.

Further, the method 500, at step 503, includes iteratively computing the optimal size, for the context window 111, such that the optimal size fits within the threshold size of the context window 111. In an embodiment, the iterative computation 300 of the optimal size includes splitting the input data into the plurality of segments, where each of the plurality of segments is split into a first size that is less than the threshold size of the context window at step 505. An example of splitting of the input data into the plurality of segments is depicted in block 401 of FIG. 4. According to an embodiment, the iterative computation 300 further includes extracting the plurality of features from each of the plurality of segments. The iterative computation 300 further includes representing the plurality of features in each of the plurality of segments as the plurality of data points in the vector using vector embedding techniques. The iterative computation method 300 further include obtaining the plurality of vectors representing the plurality of features in the plurality of segments in the vector space. An example of the plurality of vectors representing the plurality of features in the plurality of segments in the vector space is depicted in block 403 of FIG. 4.

According to an embodiment, the method 500, at step 507, includes determining the optimal number of one or more groups of segments, among the plurality of segments, where each of the one or more groups of segments is semantically close to each other. In particular, the optimal number of one or more groups of segments is determined by the optimal cluster determination techniques. In an embodiment, the optimal cluster determination techniques include obtaining one or more clusters of data points having semantically close data points based on the application of clustering techniques on the plurality of vectors. The method further includes calculating the sum of the squared error factor for each of the one or more clusters of data points. Further, the method includes determining, from the one or more clusters of data points, the optimal number of the one or more groups of segments having the optimal compactness of the data points within each of the one or more clusters of data points based on the point where the rate of decrease in the sum of the squared error factor starts to slow down. Block 405 of FIG. 4 depicts the point 407 where the rate of decrease in the sum of the squared error factor starts to slow down. The sum of the squared error factor represents the sum of a squared distance between each of the plurality of data points within the cluster of data points among the one or more clusters of data points and a corresponding centroid of the cluster of data points.

According to an embodiment, the iterative computation 300 further includes, at step 509, obtaining, based on clustering of the one or more groups of segments, one or more clusters of segments having a vector similarity within each of the one or more clusters of segments. In an embodiment, the obtaining of the one or more clusters of segments having the vector similarity within each of the one or more clusters of segments includes determining the vector similarity between the one or more groups of segments using clustering techniques. Further, the method includes clustering the one or more groups of segments using clustering techniques and obtaining the one or more clusters of segments having the vector similarity within each of the one or more clusters of segments based on a result of the determination. Block 409 of FIG. 4 depicts the one or more clusters of segments having the vector similarity within them.

According to an embodiment, the iterative computation 300 further includes, at step 511, selecting, from each of the one or more clusters of segments, the representative segment that is closest to the center of each of the one or more clusters of segments to obtain the set of representative segments. Block 411 of FIG. 4 depicts the set of representative segments.

According to an embodiment, the iterative computation method further includes, at step 513, performing the specific task by passing each representative segment, of the set of representative segments, through the LLM 100 to obtain a first output corresponding to each of the representative segments. Further, the iterative computation 300 further includes, at step 515, the obtaining, based on combining the first output, a second output of a specific size. FIG. 4 depicts the second output with label 415. According to an embodiment, the steps 503 through 515 are performed by the computation module 203.

According to an embodiment, after performing the series of operations for a first iteration as explained through steps 505 to 515 in the iterative computation 300, step 517, the method 500 further includes estimating that the specific size of the second output is the optimal size for the context window for performing the specific task using the LLM 100 based on a result of the iterative computation 300 where the specific size of the second output fits within the threshold size of the context window of the LLM 100 after the iteration. In particular, the method includes comparing the specific size of the second output with the threshold size of the context window. Further, the method includes determining that the specific size of the second output fits within the threshold size of the context window based on a result of the comparison and thereby estimating the specific size of the second output as the optimal size for the context window. In an embodiment, the step 517 is performed by the estimating module 205.

In an embodiment, the method 500 further includes invoking the LLM 100 for performing the specific task by considering the second output as a dataset for the LLM 100. For the example depicted in FIG. 4, the output module 207 performs invoking of the LLM 100 and the process at block 419. As can be seen at block 419, the LLM 100 receives the combined output 415 as the dataset and generates a final summary 421 of the document 101.

Further, based on the result of the comparison, if it is determined that the specific size of the second output does not fit within the threshold size of the context window, the method further includes repeating the iterative computation 300 of the optimal size for the context window by performing the steps 505 to 515, where the second output from a previous iteration is utilized as the input data for a next iteration. As depicted in FIG. 4, in the latter case the combined output 415 of the first iteration becomes an input to the next iteration. Thus, in the next iteration, the combined output 415 is used as the input data for performing the splitting operation and so on. In an embodiment, the iterative computation 300 is performed till the specific size of the second output fits within the threshold size of the context window 111.

According to some embodiment, the disclosed method can be implemented to perform various tasks like generating the summary, answering the queries to the large input data, and comparing the documents for various input data like large corpus of text, audio file, and video file.

The disclosed techniques overcome the constraint of a limited window size in Language Models (LLMs). By employing iterative computation, the methodology aims to reduce redundancies within the input data, thereby addressing the limitations posed by the restricted window size. This iterative process allows the LLM model to gather and process information gradually, effectively minimizing the impact of the limited window size. The disclosed method provided technical effect in the following ways:
Addressing limited window size: The “limited window size” in LLMs are always a challenge where only a fixed number of input tokens can accommodate in the LLMs context window during processing. This limitation can sometimes lead to information loss, especially when dealing with large corpus of input data. The same is being overcome by removing the redundancy in the input data by performing iterative computation. As iterative computation includes clustering and dimension reducing techniques, with each sequence of operation the redundancy in the input data is reduced. Thus, the final output hence obtained is of that size that can fit into the context window. The final output is then used for performing the final task using LLM.
Reducing redundancies: The disclosed methodology tackles this challenge by utilizing an iterative computation approach. This technique involves processing the input data by performing a sequence of operations including clustering and dimension reducing techniques, allowing the model to analyze and capture essential information while minimizing redundant content.
Eliminating the need for frequent LLM invocation: The disclosed method calls the LLM for performing the final task only when the size of the output after the iteration fits within the threshold size of the context window. The adopted methodology thus reduces the frequency of invoking the LLM for generating responses or predictions. Further, instead of requiring the LLM to process the entire input data in a single step, the iterative approach facilitates a gradual extraction of relevant information from the input, thereby lessening the need for frequent re-evaluations.

In summary, the disclosed methodology optimizes the utilization of the LLM by leveraging iterative computation to mitigate the impact of limited window size and reduce redundancies in the input data. This approach improves the necessity for recurrent LLM invocations, leading to more efficient processing and improved responsiveness in generating responses or predictions.

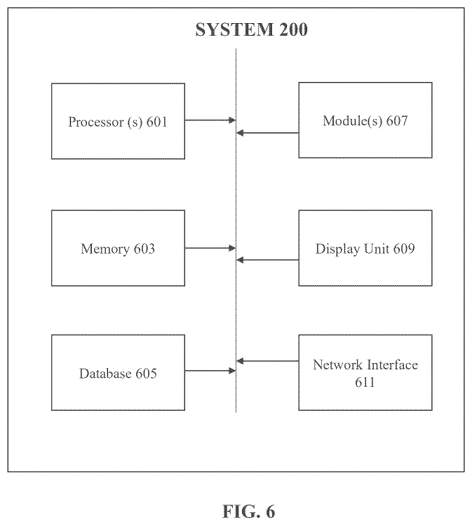

FIG. 6 illustrates a general block diagram of the system, according to an embodiment of the present disclosure.

In an example, the processor(s) 601 may be a single processing unit or a number of units, all of which could include multiple computing units. The processor(s) 601 may be implemented as one or more microprocessors, microcomputers, microcontrollers, digital signal processors, central processing units, logical processors, virtual processors, state machines, logic circuitries, and/or any devices that manipulate signals based on operational instructions. Among other capabilities, the processor(s) 601 is configured to fetch and execute computer-readable instructions and data stored in the memory 603.

The memory 603 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes.

In an example, the module(s), engine(s), and/or unit(s) 607 may include a program, a subroutine, a portion of a program, a software component or a hardware component capable of performing a stated task or function. As used herein, the module(s), engine(s), and/or unit(s) may be implemented on a hardware component such as a server independently of other modules, or a module can exist with other modules on the same server, or within the same program. The module(s), engine(s), and/or unit(s) 607 may be implemented on a hardware component such as processor one or more microprocessors, microcomputers, microcontrollers, digital signal processors, central processing units, state machines, logic circuitries, and/or any devices that manipulate signals based on operational instructions. The module(s), engine(s), and/or unit(s) 607 when executed by the processor(s) 601 may be configured to perform any of the described functionalities. According to an embodiment, the module 607 includes the receiving module 201, the computing module 203, the estimation module 205, and the output module 207. In an alternate embodiment, the functions of the aforesaid modules may be performed by the processor(s) 601.

As a further example, the database 605 may be implemented with integrated hardware and software. The hardware may include a hardware disk controller with programmable search capabilities or a software system running on general-purpose hardware. Examples of databases are but are not limited to, in-memory databases, cloud databases, distributed databases, embedded databases, and the like. The database amongst other things, serves as a repository for storing data processed, received, and generated by one or more of the processor(s) 601, and the modules/engines/units 607.

The modules/engines/units 607 may be implemented with an AI module that may include a plurality of neural network layers. Examples of neural networks include, but are not limited to, a convolutional neural network (CNN), a deep neural network (DNN), a recurrent neural network (RNN), a Restricted Boltzmann Machine (RBM), and retrieval augmented generation (RAG). The learning technique is a method for training a predetermined target device using a plurality of learning data to cause, allow, or control the target device to make a determination or prediction. Examples of the learning techniques include, but are not limited to, a supervised learning, unsupervised learning, a semi-supervised learning, or reinforcement learning. At least one of a plurality of CNN, DNN, RNN, RMB, RGB models and the like may be implemented to thereby achieve execution of the present subject matter's mechanism through an AI model. A function associated with the AI model may be performed through the non-volatile memory, the volatile memory, and the processor. The processor may include one or a plurality of processors. At this time, one or a plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors control the processing of the input data in accordance with a predefined operating rule or the artificial intelligence (AI) model stored in the non-volatile memory and the volatile memory. The predefined operating rule or artificial intelligence model is provided through training or learning.

As an example, the display unit 609 includes a computer monitor, a touch screen, an output device capable of displaying the graphics, and the like. The display unit 609 is configured to display visual output in desktops, laptops, and workstations. The display unit 609 may come in different sizes, resolutions, and types (such as LCD, LED, or OLED).

As a further example, the network interface 611 is configured to provide and establish communication with any electronic device via a public network, private network, or any wireless communication technology.

The figures of the disclosure are provided to illustrate some examples of the invention described. The figures are not to limit the scope of the depicted embodiments of the appended claims. Aspects of the disclosure are described herein with reference to the invention to example embodiments for illustration. It should be understood that specific details, relationships, and methods are set forth to provide a full understanding of the example embodiments. One of ordinary skills in the art recognize the example embodiments can be practiced without one or more specific details and/or with other methods.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Aspects of the present disclosure may be implemented as computer program products that comprise articles of manufacture. Such computer program products may include one or more software components including, for example, applications, software objects, methods, data structure, and/or the like. In some embodiments, a software component may be stored on one or more non-transitory computer-readable media, which computer program product may comprise the computer-readable media with software component, comprising computer executable instructions, included thereon. The various control and operational systems described herein may incorporate one or more of such computer program products and/or software components for causing the various conveyors and components thereof to operate in accordance with the functionalities described herein.

A software component may be coded in any of a variety of programming languages. An illustrative programming language may be a lower-level programming language such as an assembly language associated with a particular hardware architecture and/or operating system platform/system. Other example of programming languages include, but are not limited to, a macro language, a shell or command language, a job control language, a scripting language, a database query, or search language, and/or report writing language. In one or more example embodiments, a software component comprising instructions in one of the foregoing examples of programming languages may be executed directly by an operating system or other software component without having to be first transformed into another form. A software component may be stored as a file or other data storage methods. Software components of a similar type or functionally related may be stored together such as, for example, in a particular directory, folder, or repository. Software components may be static (e.g., pre-established, or fixed) or dynamic (e.g., created or modified at the time of execution).

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed:

1. A method for estimating an optimal size for a context window of a large language model (LLM), the method comprising:
receiving input data for performing a specific task, wherein the input data has a size more than a threshold size of the context window;
iteratively computing the optimal size, for the context window, such that the optimal size fits within the threshold size of the context window, wherein the iterative computation of the optimal size comprises:
splitting the input data into a plurality of segments, wherein each of the plurality of segments is split into a first size that is less than the threshold size of the context window;
determining an optimal number of one or more groups of segments, among the plurality of segments, wherein each of the one or more groups of segments is semantically close to each other;
obtaining, based on clustering of the one or more groups of segments, one or more clusters of segments having a vector similarity within each of the one or more clusters of segments;
selecting, from each of the one or more clusters of segments, a representative segment that is closest to a center of each of the one or more clusters of segments to obtain a set of representative segments;
performing the specific task by passing each representative segment, of the set of representative segments, through the LLM to obtain a first output corresponding to each of the representative segment; and
obtaining, based on combining the first output, a second output of a specific size; and
estimating that the specific size is the optimal size for the context window for performing the specific task using the LLM based on a result of the iterative computation where the specific size of the second output fits within the threshold size of the context window of the LLM after an iteration.

2. The method of claim 1, wherein estimating that the specific size is the optimal size for the context window comprises:
comparing the specific size of the second output with the threshold size of the context window;
determining that the specific size of the second output fits within the threshold size of the context window based on a result of the comparison; and
estimating the specific size of the second output as the optimal size of the context window.

3. The method of claim 2, wherein determining that the specific size of the second output does not fit within the threshold size of the context window based on the result of the comparison, the method further comprising:
repeating the iterative computation of the optimal size for the context window, wherein the second output from a previous iteration is utilized as the input data for a next iteration.

4. The method of claim 1, further comprising:
extracting a plurality of features from each of the plurality of segments;
representing, using vector embedding techniques, the plurality of features in each of the plurality of segments as a plurality of data points in a vector; and
obtaining a plurality of vectors representing the plurality of features in the plurality of segments in a vector space.

5. The method of claim 4, wherein the optimal number of the one or more groups of segments are determined by optimal clusters determination techniques, wherein the optimal clusters determination techniques comprises:
obtaining one or more clusters of data points having semantically close data points based on an application of clustering techniques on the plurality of vectors;
calculating a sum of a squared error factor for each of the one or more clusters of data points; and
determining, from the one or more clusters of data points, the optimal number of the one or more groups of segments having an optimal compactness of the data points within each of the one or more clusters of data points based on a point where a rate of decrease in the sum of the squared error factor starts to slow down.

6. The method of claim 5, wherein the sum of the squared error factor represents the sum of a squared distance between each of the plurality of data points within a cluster of data points among the one or more clusters of data points and a corresponding centroid of the cluster of data points.

7. The method of claim 1, wherein obtaining the one or more clusters of segments having the vector similarity within each of the one or more clusters of segments comprises:
determining the vector similarity between the one or more groups of segments using clustering techniques;
clustering the one or more groups of segments using clustering techniques; and
obtaining the one or more clusters of segments having the vector similarity within each of the one or more clusters of segments based on a result of the determination.

8. The method of claim 1, further comprising:
invoking the LLM, for performing the specific task using the second output, with the optimal size of the context window based on the estimation that the specific size of the second output is the optimal size; and
performing the specific task by passing the second output into the LLM as a dataset.

9. The method of claim 1, wherein the second output includes segments with non-redundant input data.

10. The method of claim 1, wherein the threshold size of the context window is the size that the LLM is capable of successfully processing the input data.

11. A system for estimating an optimal size for a context window of a large language model (LLM), comprising:
one or more processors;
a memory; and
one or more programs stored in the memory, the one or more programs when executed by the one or more processors cause the one or more processors to:
receive input data for performing a specific task, wherein the input data has a size more than a threshold size of the context window;
iteratively compute the optimal size, for the context window, such that the optimal size fits within the threshold size of the context window, wherein the iterative computation of the optimal size comprises:
split the input data into a plurality of segments, wherein each of the plurality of segments is split into a first size that is less than the threshold size of the context window;
determine an optimal number of one or more groups of segments, among the plurality of segments, wherein each of the one or more groups of segments is semantically close to each other;
obtain, based on clustering of the one or more groups of segments, one or more clusters of segments having a vector similarity within each of the one or more clusters of segments;
select, from each of the one or more clusters of segments, a representative segment that is closest to a center of each of the one or more clusters of segments to obtain a set of representative segments;
perform the specific task by passing each representative segment, of the set of representative segments, through the LLM to obtain a first output corresponding to each of the representative segment; and
obtain, based on combining the first output, a second output of a specific size; and
estimate that the specific size is the optimal size for the context window for performing the specific task using the LLM based on a result of the iterative computation where the specific size of the second output fits within the threshold size of the context window of the LLM after an iteration.

12. The system of claim 11, wherein to estimate that the specific size is the optimal size for the context window, the one or more processors are configured to:
compare the specific size of the second output with the threshold size of the context window;
determining that the specific size of the second output fits within the threshold size of the context window based on a result of the comparison; and
estimating the specific size of the second output as the optimal size of the context window.

13. The system of claim 12, wherein to determine that the specific size of the second output does not fit within the threshold size of the context window based on the result of the comparison, the one or more processors are further configured to:
repeat the iterative computation of the optimal size for the context window, wherein the second output from a previous iteration is utilized as the input data for a next iteration.

14. The system of claim 11, wherein the one or more processors are further configured to:
extract a plurality of features from each of the plurality of segments;
represent, using vector embedding techniques, the plurality of features in each of the plurality of segments as a plurality of data points in a vector; and
obtaining a plurality of vectors representing the plurality of features in the plurality of segments in a vector space.

15. The system of claim 14, wherein the optimal number of the one or more groups of segments are determined by optimal clusters determination techniques, wherein for the optimal clusters determination techniques the one or more processors are configured to:
obtain one or more clusters of data points having semantically close data points based on an application of clustering techniques on the plurality of vectors;
calculate a sum of a squared error factor for each of the one or more clusters of data points; and
determine, from the one or more clusters of data points, the optimal number of the one or more groups of segments having an optimal compactness of the data points within each of the one or more clusters of data points based on a point where a rate of decrease in the sum of the squared error factor starts to slow down.

16. The system of claim 15, wherein the sum of the squared error factor represents the sum of a squared distance between each of the plurality of data points within a cluster of data points among the one or more clusters of data points and a corresponding centroid of the cluster.

17. The system of claim 11, wherein to obtain the one or more clusters of segments having the vector similarity within each of the one or more clusters of segments, the one or more processors are configured to:
determine the vector similarity between the one or more groups of segments using clustering techniques;
cluster the one or more groups of segments using clustering techniques; and
obtain the one or more clusters of segments having the vector similarity within each of the one or more clusters of segments based on a result of the determination.

18. The system of claim 11, wherein the one or more processors are further configured to:
invoke the LLM, for performing the specific task using the second output, with the optimal size of the context window based on the estimation that the specific size of the second output is the optimal size; and
perform the specific task by passing the second output into the LLM as a dataset.

19. The system of claim 11, wherein the second output includes segments with non-redundant input data.

20. A non-transitory computer-readable storage medium storing program instructions for estimating an optimal size for a context window of a large language model (LLM), the program instructions, when executed, perform the steps of:
receiving input data for performing a specific task, wherein the input data has a size more than a threshold size of the context window;
iteratively computing the optimal size, for the context window, such that the optimal size fits within the threshold size of the context window, wherein the iterative computation of the optimal size comprises:
splitting the input data into a plurality of segments, wherein each of the plurality of segments is split into a first size that is less than the threshold size of the context window;
determining an optimal number of one or more groups of segments, among the plurality of segments, wherein each of the one or more groups of segments is semantically close to each other;
obtaining, based on clustering of the one or more groups of segments, one or more clusters of segments having a vector similarity within each of the one or more clusters of segments;
selecting, from each of the one or more clusters of segments, a representative segment that is closest to a center of each of the one or more clusters of segments to obtain a set of representative segments;
performing the specific task by passing each representative segment, of the set of representative segments, through the LLM to obtain a first output corresponding to each of the representative segment; and
obtaining, based on combining the first output, a second output of a specific size; and
estimating that the specific size is the optimal size for the context window for performing the specific task using the LLM based on a result of the iterative computation where the specific size of the second output fits within the threshold size of the context window of the LLM after an iteration.
